(19) United States
(12) Patent Application Publication
(10) Pub. No.: US 2008/0313980 A1
(43) Pub. Date: Dec. 25, 2008

(54) ZIPPERED STORM PANEL SYSTEM FOR WINDOWS AND DOORS

(75) Inventors: John E. Holland, Bailey, NC (US); Connie W. Holland, Bailey, NC (US); Daniel M. Nathan, Wendell, NC (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: JHRG, LLC, Spring Hope, NC (US)

(21) Appl. No.: 12/132,318

(22) Filed: Jun. 3, 2008

Related U.S. Application Data
(63) Continuation-in-part of application No. 11/849,691, filed on Sep. 4, 2007.
Application No. 11/849,691 is a continuation-in-part of application No. 11/767,753, filed on Jun. 25, 2007.

(51) Int. Cl. E06B 3/26

(52) U.S. Cl. 52/202

(57) ABSTRACT

A storm panel system for protecting the interior of a building having a fabric panel of a size and shape as to extend across a selected door or window is provided. A closure system accessible from the outside removably attaches the fabric panel to the outer surface of a building surrounding a window or door opening. The fabric panel has at least one access opening which is selectively closeable at the user's election. The selectively closeable access opening allows access through the opening to the outside to attach and release the panel from the structure by a person from inside the structure. Thus a user can access the exterior of building to install, adjust or remove the fabric panel, before during or after a storm.

### CROSS REFERENCE TO RELATED APPLICATIONS

This is a continuation-in-part of application Ser. No. 11/849,691, filed Sep. 4, 2007, still pending, which is a continuation-in-part of application Ser. No. 11/767,753, filed Jun. 25, 2007, still pending.

### FIELD OF INVENTION

This invention relates to improvements in storm panel systems which protect property against damage caused by high winds and impact from associated flying objects and debris that result from a hurricane or other occurrence.

### BACKGROUND

Various devices and materials have been proposed for the protection of building openings (such as windows, doors, and sliding glass doors) from the effects of high winds and flying objects associated with a hurricane or similar event. They include plywood sheets, corrugated metal panels, heavy translucent stiff corrugated plastic sheets out of such materials as poly carbonate, flexible metal shutters, and the like. In the simplest and most often utilized form, sheets of plywood have been nailed, screwed, or otherwise attached to a building as a covering for windows and doors. The user needs to acquire and cut plywood sheets to the proper dimensions to cover the openings and to install them. Because of their appearance, bulkiness and weight, plywood covers are typically installed only when a hurricane or similar incident is imminent. During the hurricane or other storm, the plywood prevents any light from entering into the building and electricity frequently gets interrupted during hurricanes. As a result, the covered windows and doors produce a cave-like effect that is uncomfortable and inconvenient to the building occupants. After the threat of damage has passed, the plywood sheets must be removed by hand. The securing system (nails, etc.) may cause damage to the building structure.

Lately there have been various attempts at implementing protective systems as storm panels. These systems are usually permanently affixed to a structure. The fabric panel is stored in a coiled configuration positioned above a window or door inside a housing in anticipation of threat from flying debris. The panel can be deployed over a window or door opening.

### SUMMARY OF THE INVENTION

One aspect of the present invention is the recognition that the aforementioned system and devices are both burdensome and dangerous to install and remove. For two or three-story buildings, or even single-level buildings that are elevated, the user is confronted with a problem of safe and secure access to the upper level windows. Thus, a user will need a ladder, scaffold, or lift device to gain access to install, and later remove, the aforementioned devices. If a user is installing these devices and the weather quickly deteriorates-this user is left exposed elements of a storm and possible projectiles. Where the threat of damage has passed, the user is still placed in an unnecessary and dangerous predicament in order to remove the protective panels describe above. Even protective systems that are permanently affixed to the building may require a user to access the structure from the exterior to ensure proper engagement of the structure to building before a storm.

Thus, despite the existence of such storms for many, many years, and despite the existence of materials and many types including fabrics, the above procedures are still necessary. Lately, storm panel systems have been developed, that are lightweight, translucent, simple to install and remove. These inventive systems remove the impediments of installation associated with an elevated building opening, and when constructed and installed in accordance with the teachings of the present invention, will protect window or door openings from debris or airborne objects occurring during high winds such as those accompanying hurricanes or other violent storms.

One approach described in the parent application Ser. No. 11/767,753, is a system having a fabric panel of high strength yarns, such as high molecular weight polyethylene yarns. The fabric is of a size and shape as to extend across a selected door or window. A reinforcement member may be disposed along at least a portion of the perimeter of the fabric panel and removably engages the outer surface of a building surrounding a window or door opening. The fabric panel and reinforcement member cooperate to cover at least a portion of the selected window or door opening of a building, however, a preferred embodiment of the inventive system deploys a fabric panel in an overlapping manner over the door or windowing opening.

Also according to the parent application Ser. No. 11/849,691, there is provided at least one access opening in the fabric panel of high strength yarns. In the case of elevated windows, the access opening permits a user to install or remove the fabric panel while remaining inside of the building. Thus, the access opening avoids the inconvenient and potentially dangerous circumstances surrounding installation and/or removal of prior protective systems on elevated windows. The access opening is selectively closeable at the user's election, whereby a user can access the exterior of building to install, adjust or remove the fabric panel, before during or after a storm. Thus, the opening obviates the need for the property owner or user to climb ladders or even exit the building into the elements of the storm, should the need arise.

In use, a storm panel system is installed over the window or door opening so as to store the fabric panel in a rolled or coiled configuration for later deployment when the threat of damage is near. At the user's election, the fabric panel can be deployed to cover the window or door. The access opening permits a user to secure the fabric panel to the outer surface of a building surrounding a window or door opening when deployed.

Applicant has now discovered that the concept of the access opening in the fabric panel is also applicable to other storm panel systems that utilize other types of flexible panels to cover window or door openings. This would include flexible panels of conventional organic and polymeric yarns, blends thereof, polymeric films, or even film/fabric laminates and coated fabrics. The concept is also applicable to systems in which other mounting systems may be utilized such as those disclosed in U.S. Pat. Nos. 6,341,455; 6,851,464; and 6,886,300, as well as in U.S. Published Application No. 2004/0154242. Thus, the provision of the access opening is applicable to substantially all flexible panel storm covers, however they may be mounted, so long as the mounting process or the deployment of the flexible panel requires access from the outside.

### BRIEF DESCRIPTION OF DRAWINGS

Having described the invention in general terms, reference will now be made to the accompanying drawings, which are not necessarily drawn to scale, and wherein:

FIG. 1 is a perspective view of a window having installed thereon a storm panel of the present invention, shown rolled down in readiness for a storm;

FIG. 1A is a perspective view of a door having installed thereon a storm panel of the present invention, shown rolled down in readiness for a storm;

FIG. 2 is a perspective view similar to FIG. 1, except showing the panel in the rolled up, stored position;

FIG. 3A is a front elevational view of a panel for a window, having a horizontal access opening formed therein;

FIG. 3B is a rear elevational view of the panel of FIG. 3A;

FIG. 3C is a front elevational view of a panel for a door, having a vertical access opening formed therein;

FIG. 3D is a rear elevational view of the panel of FIG. 3C;

FIG. 4 is an enlarged sectional view taken substantially along lines 4-4 in FIG. 3 and illustrating the relative positioning of the reinforcing strip, the grommet, and the fabric;

FIG. 5 is an enlarged sectional view taken substantially along lines 5-5 in FIG. 3 and illustrating a panel seam;

FIG. 6A is an enlarged partial perspective illustrating how the panel hem, connecting strip, and protective cover are attached to the face of a facing;

FIG. 6B is a view similar to FIG. 6A, except showing the panel rolled up and the cover and c-clip in place;

FIG. 6C is a view similar to FIG. 6B, except showing the panel rolled up with the cover secured by flexible straps;

FIG. 7A is a perspective view of the c-clip alone removed from the storm panel;

FIG. 7B is a perspective of an alternate form of the c-clip;

FIG. 8A is a cross-sectional view of a window frame with the storm panel attached illustrating how the anchor screws attach the storm shade to a window facing; and

FIG. 8B is a view similar to FIG. 6, except showing the storm panel attached to the underside of a window facing.

FIG. 9 is perspective view of another embodiment of the closure system in which the flexible storm panel is partially stored in a housing when not in use.

### DESCRIPTION OF ONE OR MORE OF PREFERRED EMBODIMENTS

Certain exemplary embodiments of the present invention are described below and illustrated in the accompanying Figures. The embodiments described are only for purposes of illustrating embodiments of the present invention and should not be interpreted as limiting the scope of the invention. Other embodiments of the invention, and certain modifications and improvements of the described embodiments, will occur to those of skill in the art, and all such alternate embodiments, modifications and improvements are within the scope of the present invention.

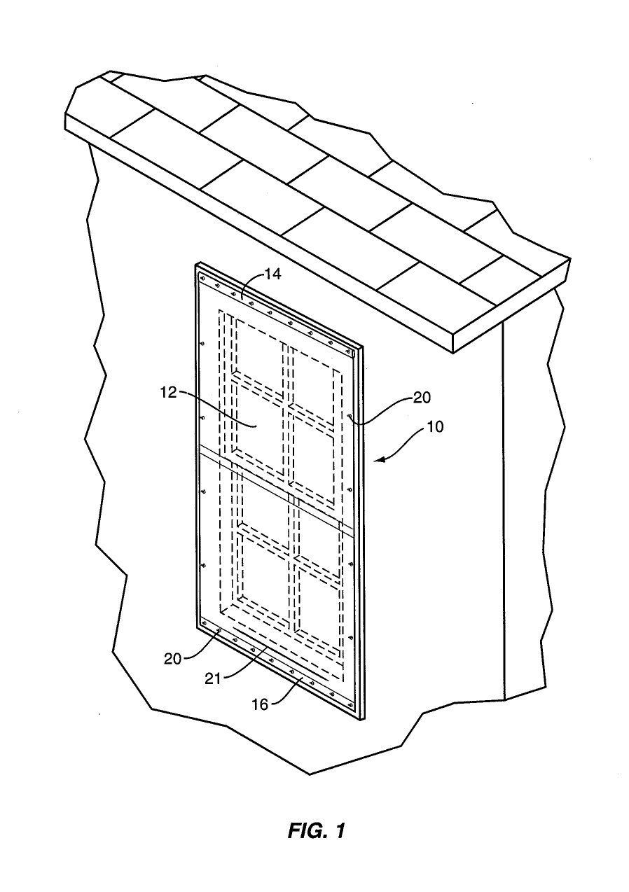

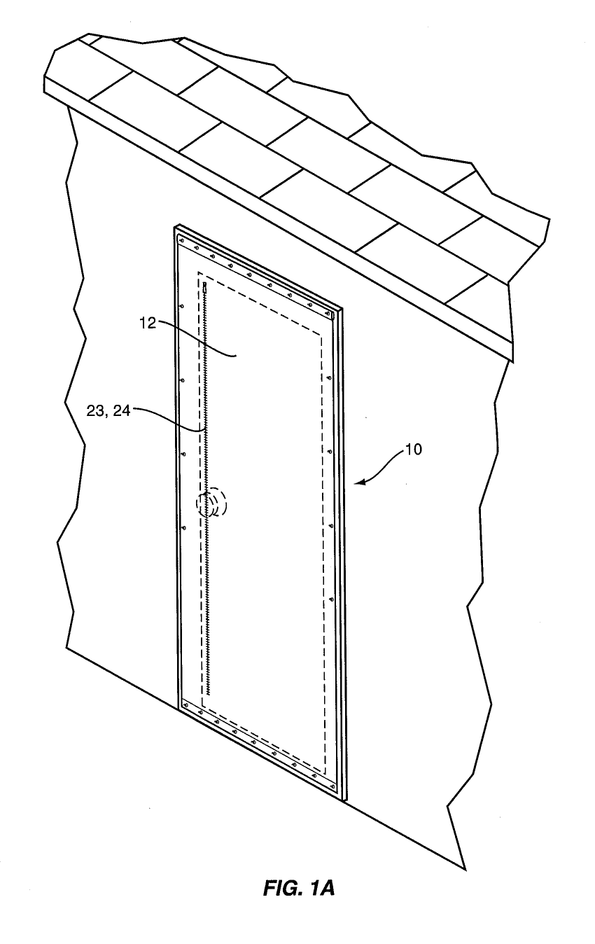

Turning now to the drawings, a storm panel for windows, doors, sliding doors, and the like is illustrated in FIGS. 1-3. The storm panel is shown generally as reference 10 and is illustrated installed over a window of a house. The storm panels can be of various lengths and widths to cover various size openings, such as windows, double windows, doors, sliding doors, etc. By “storm panel” it is meant flexible material suitable for covering a window or door opening that is intended to provide protection to the interior from flying objects associated with a hurricane or similar event.

The storm panel is preferably a fabric, a polymeric film, a film/fabric laminate, or a coated fabric laminate. By “fabric” we mean any structure formed form fibers or yarns and includes woven fabrics, warp knit fabrics, weft knitted fabrics, mesh fabrics and nonwoven fabrics. More preferable is woven fabric formed as a plain weave. In other embodiments, the woven fabric can be basket weave, twills or satins as the need may arise. The inventors contemplate the use of any fabric structure where the interlacing yarns or fibers provide sufficient strength and dimensional stability for use as a storm panel 10.

The fabric is preferably comprised of synthetics fibers. Examples of synthetic fibers and yarns used to form the fabrics for use as panel is present invention include polyester, polyamide, polypropylene, ultra high molecular weight polypropylene, polylactic acid, acrylic, polyethylene, ultra high molecular weight polyethylene (such as SPECTRA® by Honeywell), aramids, para aramids, ultra high molecular weight aramids, and those formed of blends of such compositions. Continuous filaments yarns are preferred, however spun yarns can also be used.

In another embodiment, the storm panel 10 is a film alone or a laminate of a fabric layer and a film. By “film” we refer to a planar polymeric material. Some examples of the films contemplated for use alone or in conjunction with a fabric to form a storm panel 10 include polyethylene, low density polyethylene, ethylene, and vinyl acetate films. The film can be laminated on the fabric as is known in art.

Another embodiment of storm panel 10 is a coated fabric. A coated fabric, as used for the present invention is where a polymer coating such as acrylic, polyvinyl chloride, polyvinyl acetate, polyurethane is disposed on a surface of the fabric. By “coating” we refer to the formation of a polymer material onto the fabric. The coating is applied by methods known in art such as extrusion, knife, spray, foam, froth, rotary screen, pad, gravure methods or transfer coating methods. One embodiment of storm panel 10 is a vinyl coated woven fabric formed from polyester yarns.

In any particular combination described above such a fabric, a film, a fabric-film laminate, or a coated fabric, the storm panel 10 will typically have a basis weight of less than about 60 ounces per square yard, preferably less than about 40 ounces per square yard and more preferably less than about 20 ounces per square yard.

As best illustrated in FIGS. 1 through 3, in one embodiment, storm panel 10 includes a fabric panel 12 having a perimeter and an upper and lower hem 14, 16 forming a portion of the perimeter. FIG. 1 is exemplary of a storm panel installed on a window, and FIG. 1A is exemplary of a storm panel installed on an entry door.

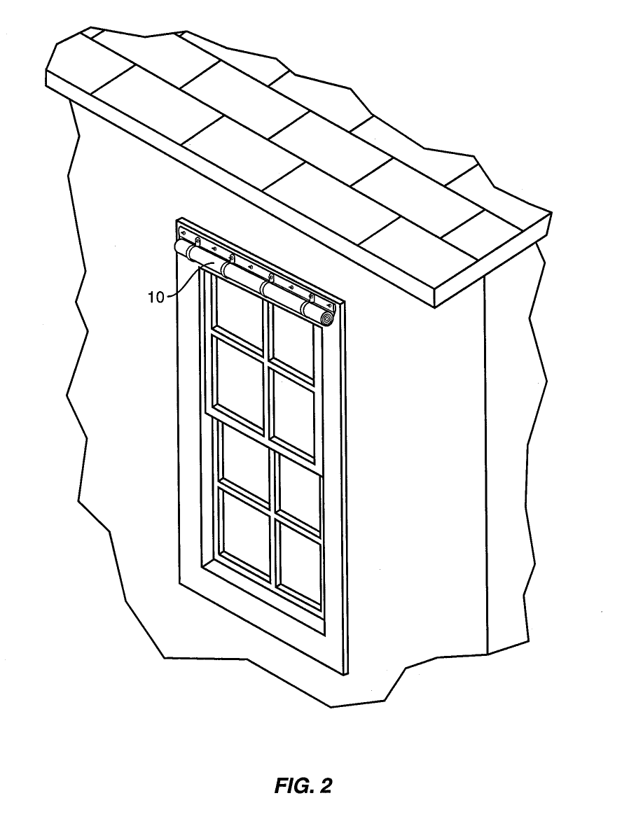

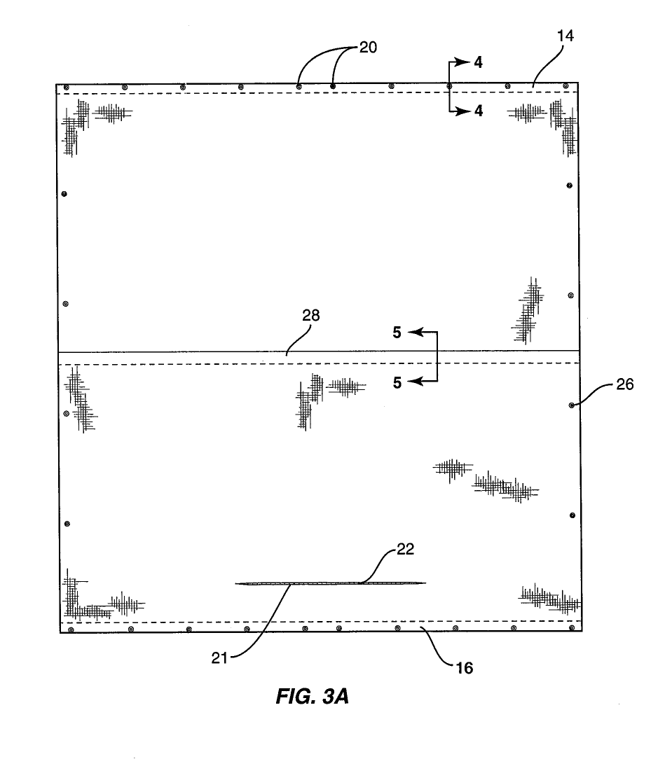

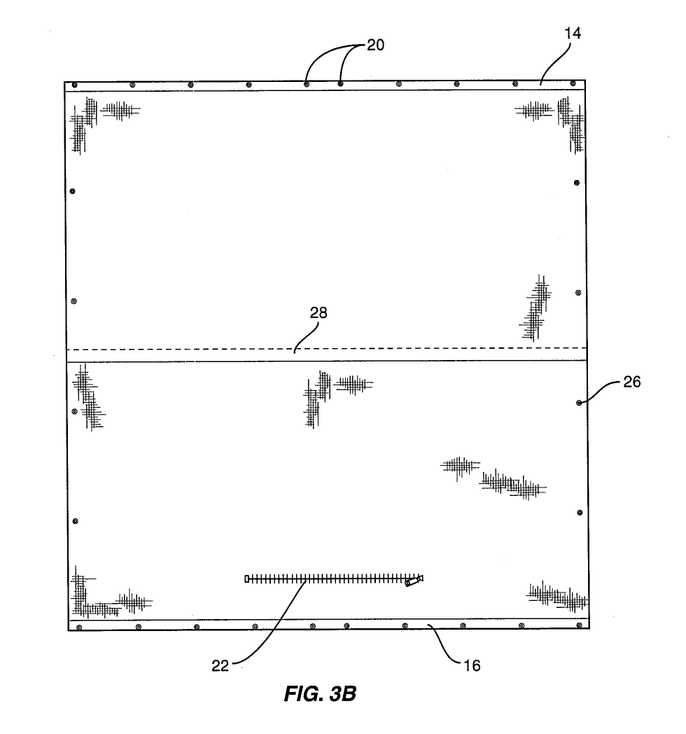

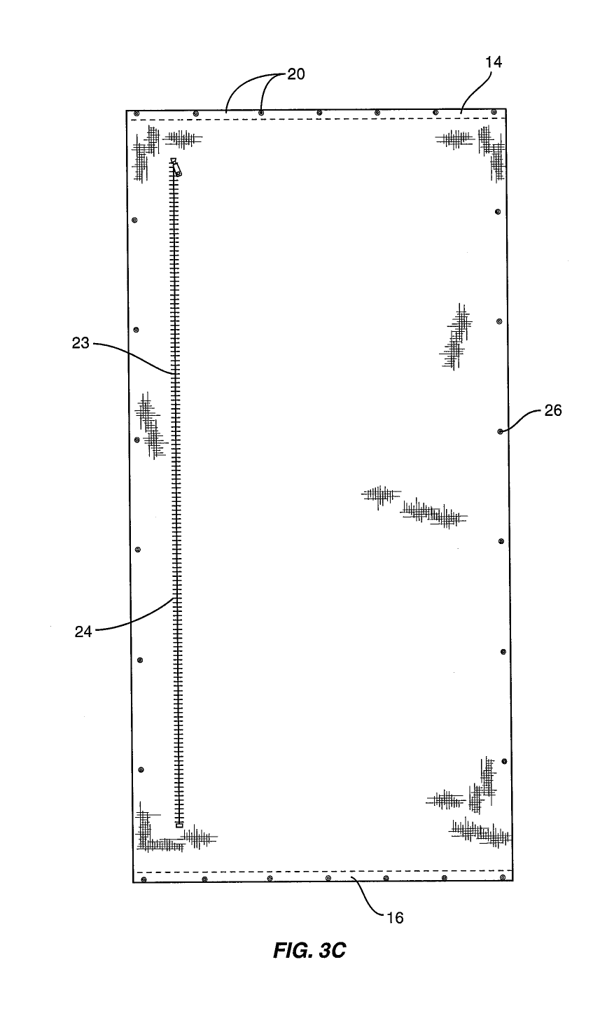

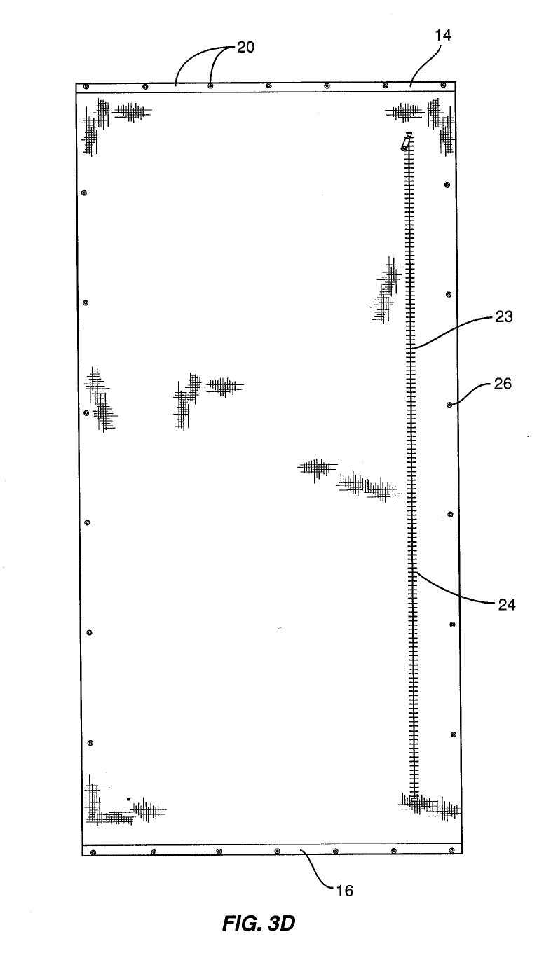

Referring now to FIGS. 3A through 3D, a selectively closeable elongate opening of the storm panel 10 is illustrated. As shown in outside view of FIG. 3A, an opening 21, or horizontal slit is formed preferably proximate the lower hem 16 of the fabric panel 12. FIG. 3A is illustrative of a storm panel configuration for a window in which the panel necessarily must be installed on upper floors or elevations of the structure where a ladder, scaffolding, or the like would normally be required to ready the panel for an impending storm. From the outside of the panel the elongated slit 21 is not noticeably visible when closed since little or no material may be actually removed in cutting the opening 21. Formed in this manner, the opening 21 affords very little exposure to or through the opening 21 which aids in preventing any unwanted intrusion of water, or the potential of damage to the panel 10 during a storm.

Turning to FIG. 3B, the inner side of the panel 10 is illustrated. A closure material, such as a zipper 22, is affixed along the length of the elongate opening 21 so that the opening 21 may be selectively opened and closed for outer panel access. Thus, during installation with the panel 10 unrolled in front of the window, an installer may simply unzip the zipper 22 closure and reach through the opening 21 to mount the lower hem 16 using the mounting system 30 described below. As will be discussed below, depending on the closure system employed, the installer may need to firth deploy the stored panel 10 over the window opening. Upon the deployment of the panel 10, the installer can then unzip the zipper 22 closure and reach through the opening 21 to mount the remaining portion of the panel 10 to the structure. Upon completion of the installation, the zipper is then closed and the panel 10 is ready for the storm. As will be appreciated, the placement and/or the relative length of the slit/opening 21 may vary (increased, for example) to accommodate storm panels of different widths. Further, rather than a single opening 21, multiple spaced openings may be provided, or multiple openings may be formed at different heights to accommodate the installation of the sides of the panel to the structure, when that feature is provided for the particular panel.

One suitable zipper type is a heavy-duty molded plastic zipper (resists corrosive effects of salt and seawater) such as the No. 15 Big Zip, available from Lenzip Manufacturing Corporation as Part No. 1540E. Alternatively, other closure materials or fasteners may be used, including but not limited to hook-and-loop, i.e., VELCRO® strip material, buttons, snaps, etc.

Referring now to FIGS. 3C and 3D, another embodiment provides a storm panel for doors. As shown in FIG. 3C, a vertically elongated opening 23 is formed proximate one of the vertical side edges of the panel 10/door opening. Since the panel 10 for an entry door may normally be installed from the outside without the need for extension ladders, the opening 23 in this panel is formed on the side of the door on which the door knob or door latch is located so that an individual may enter and exit through the doorway and through the opening 23 even with the panel 10 installed. As shown in FIG. 3C, such as a zipper 24, again is provided so that the panel may be selectively opened and closed. In the case of a door, however, it may be desirable to have a double zipper or other similar closure such that the panel 10 may be opened and closed from either inside or outside. One suitable double zipper is the No. 15 Big Zip, Part No. 1541E, which is again a heavy duty, corrosion-resistant zipper. Obviously, although not shown, the zippered storm panel may be configured for sliding glass doors.

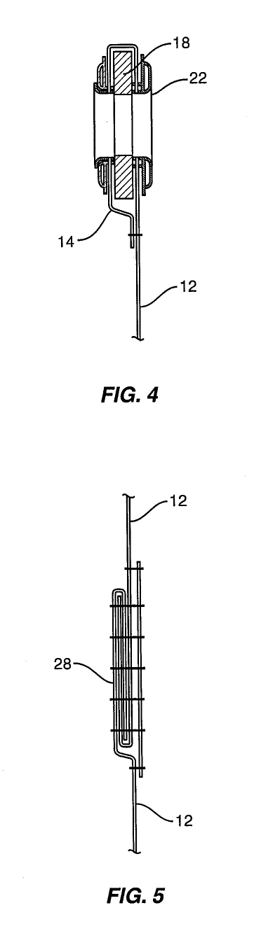

A variety of closure system are contemplated by the inventors. By “closure system” we mean a system for releaseably securing a panel to a structure surrounding a window or door in advance of a storm. FIGS. 4 through 9 show embodiments of a closure system 30 that is capable of selectively attaching a panel 10 to the structure surrounding a window or door in advance of a storm. Each of the closure systems embodied in the accompanying figures are releasable from the structure surrounding the window after the storm has passed. A preferred embodiment of the closure system 30 is shown where the panel 10 is selectively attached to the structure using a series of holes, screws, garments and reinforcing strips. Other embodiments of the closure system are permanently affixed to the structure where the fabric panel may be stored year round in a coiled position above (or to either side) of a window or door opening. In the preferred embodiment a flat reinforcing bar 18 (FIG. 4) in the form of an aluminum, or other metal, plastic, or other similar material strip is inserted in each hem 14, 16. The purpose of the strip is to reinforce the points of attachment, so that when extremely high winds are prevalent, excessive stress is taken off the fabric itself. A plurality of spaced openings 20 extend along the upper and lower hems through the fabric material and the reinforcing strips. The spaced openings or holes are spaced apart a distance of from 4-12 inches, depending upon the anticipated forces that the panel is intended to withstand. Obviously, the closer the openings, the higher the wind force intended to be withstood. Grommets 22 (FIG. 4) are placed through the openings in the hems and strips. Optional aspects of the fabric panel 12 include additional side openings 26, so that the fabric panel can be fastened on the sides as well as at the top and bottom. Also, in the cases of a larger window opening, the fabric panel 12 may have to have one or more seams 28. Such a seam is best shown in FIG. 5.

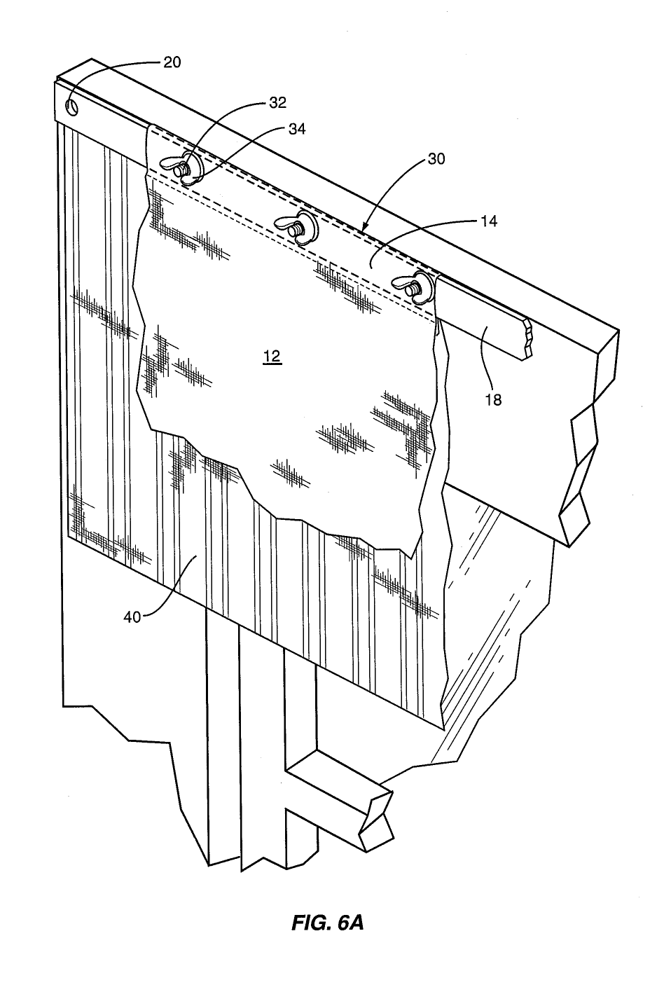

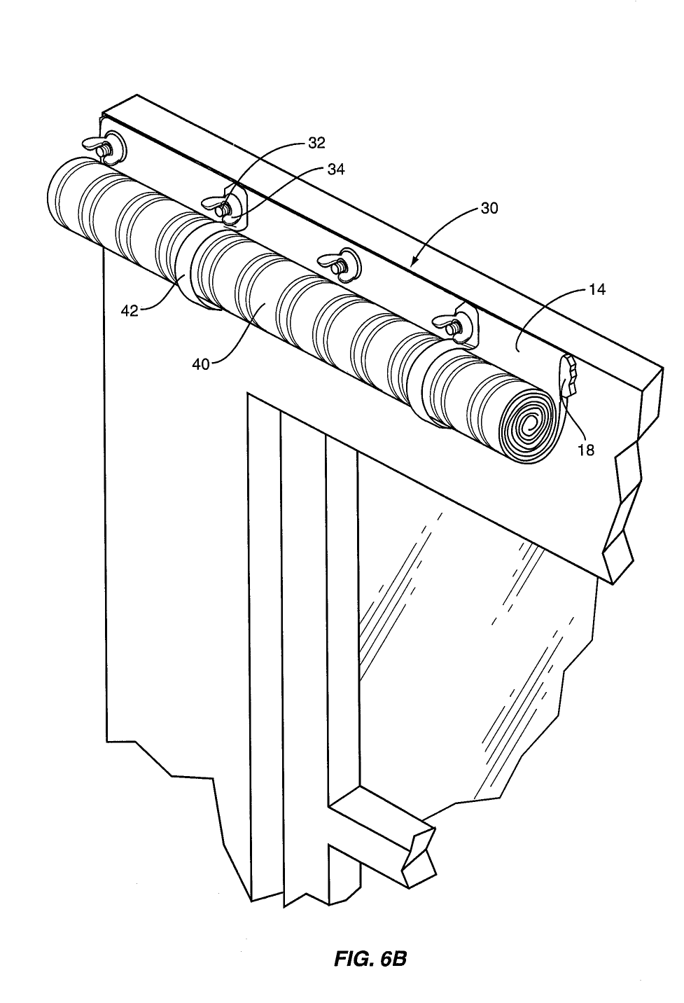

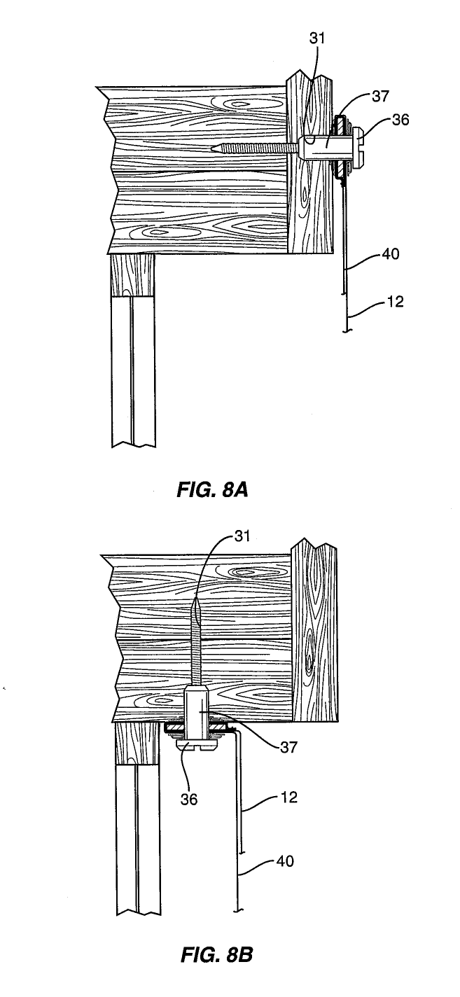

Turning now to FIGS. 6A, 6B, 8A, and 8B, there is better illustrated the one embodiment of a closure system 30 that shows the manner in which the storm panel 10 is installed to the building. First, guide holes 31 are drilled in the framing, facing, or other area around the window opening to a depth of 1-2 inches depending upon the type of anchor screw used. Two types of anchor screws which will satisfactorily anchor the panel include the Tapcon SG 32 with washered wingnut 34 by ITW Buildex and the Sammy Super Screw 36 also by ITW Buildex, the difference being that the Tapcon SG 32 (illustrated in FIG. 6A) includes a threaded shaft extending outwardly of the structure, and a washered wingnut 34 is used to tighten down against the hem 14, 16. The Sammy Super Screw 36 (FIG. 8A) differs in that there is no wingnut, and the screw includes a stainless steel cap that overlies the hem and is inserted through the hem as the screw is attached. The Sammy Super Screw also includes an enlarged shoulder 37 (FIG. 8A) to provide reinforcement of the screw shank.

While the screw type anchors shown above are illustrative of the types of anchors that can be used, other types of anchoring means can also be used depending upon whether the structure is wood, concrete, concrete block, brick, stucco, etc., it being understood that the type of anchor should be selected depending upon the type material into which it must be inserted and secured. The process involves lining up the holes in the wall with the openings in the hem and reinforcing strip. The hole positions are marked on the wall, and then using a drill, drilling a hole into the wall an appropriate depth and diameter. The fabric panel 12 is then attached by securing the upper hem 14 to the portion of the wall above the wall opening, then securing the lower hem 16 to the area below the opening in the same manner. If the optional side openings are used, the sides are then secured in the same manner.

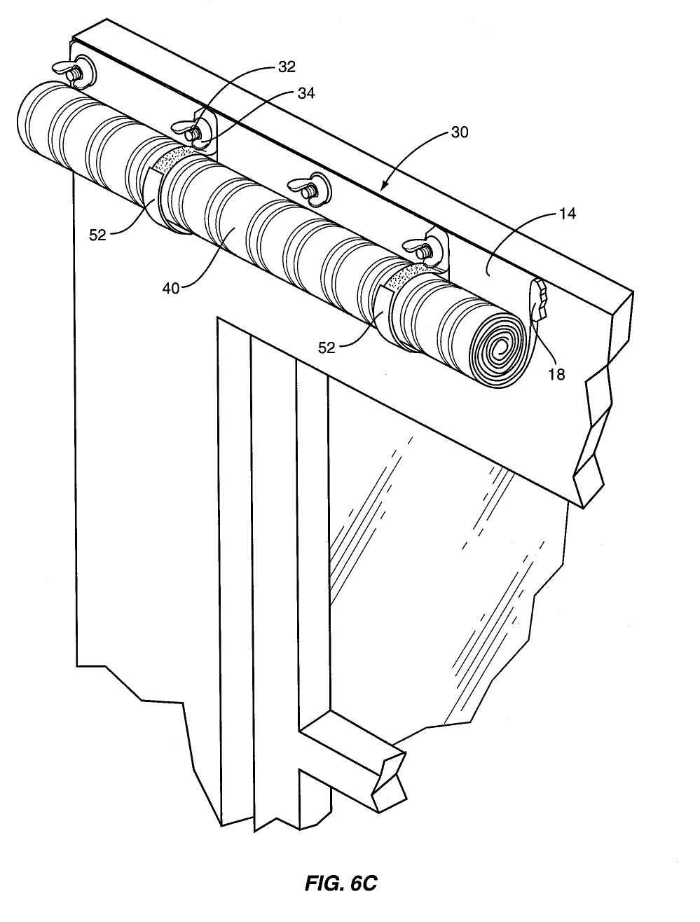

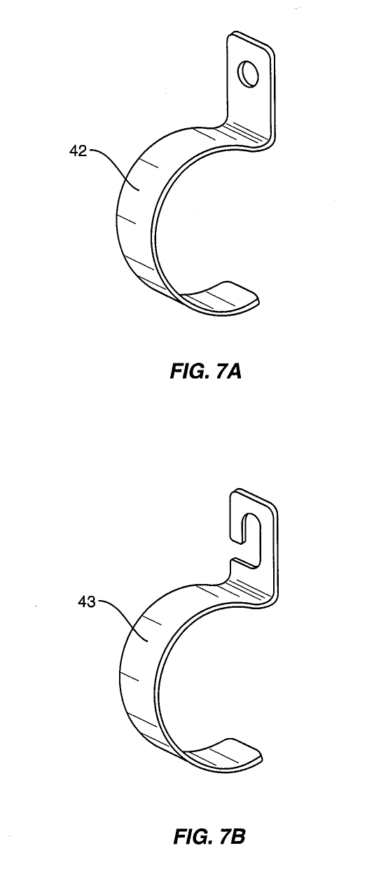

In FIG. 6B, there is illustrated one example of how the fabric panel 12 may be stored and placed in times when a storm is not imminent. To move the panel to the stored position above the window, the lower hem 16 and its reinforcing bar 18 are released from the lower side of the opening, rolled up, and then stored in its upper position by means of one or more c-clips 42 which are also attached to the anchor screws 32. Obviously, the c-clips 42 must be removed before emplacing the storm panel in its protective position, then replaced when the panel 12 is rolled up to its stored position. The same anchor screws 32 are used secure both the storm panel 12 and the c-clips. One type of c-clip 42 is illustrated in FIG. 7A. This type of c-clip requires the complete removal of the corresponding anchor screw 36 or wingnut 34 to emplace or remove the c-clip. Alternatively, a slotted c-clip 43 (FIG. 7B) may be used, which only requires a loosening of the anchor screw 36 or wing nut 34 for emplacement or removal.

An attractive protective cover 40 of some suitable material such as a solution dyed acrylic fabric such as SUNBRELLA® by Glen Raven may optionally be provided. The protective cover 40, as illustrated in FIGS. 6A and 6B is suitably attached adjacent to or around upper hem 14, and then folded around the storm panel in the rolled up position, whereupon the c-clips 42 maintain the cover and the rolled up fabric panel 12 in the stored position until the time arrives to install the panel in its protective position again.

While FIG. 6A, 6B are illustrative of a system in which the cover 40 is behind the panel 12, and the panel 12 and cover 40 are rolled to the outside, the cover 40 could be placed on the outside and the panel 12 could be rolled in either direction.

FIG. 6C is illustrative of another method by which the cover 40 and panel 12 may be rolled up and secured to the outside of the structure. One or more flexible straps 52 may be spaced along the upper hem 14 of the panel 10. Each of the flexible straps 52 may comprise two strap pieces which are joined together once the panel 12 and cover 40 are rolled up. Alternatively, each strap 52 may also be formed of a single strap with the hook and loop fastening material being appropriately arranged therein. In one embodiment, the flexible straps 52 comprise the same fabric as the panel 12 with a hook-and-loop material appropriately secured thereto for selectively tightening around the rolled up panel and cover combination. As will be appreciated, the flexible straps 52 may be secured by the anchor screws 32 or may be attached to the panel and/or cover directly. Other suitable fasteners such as snaps, buttons, etc. again may be selected depending upon the particular configuration of the panel. Alternatively, the straps 52 may be formed of longer lengths so that they may be tied together to secure the rolled up panel and cover.

FIGS. 8A and 8B illustrate how the panel is installed. The anchor screws 36 may be attached to the vertical exposed surface of a window facing (FIG. 8A) or attached to the under surface of a window facing (FIG. 8B). From the illustration, it appears obvious as to how these approaches are facilitated. Obviously, the fabric panel 12 could be similarly stored beneath the window, or in the case of windows, doors, or sliding glass doors, the fabric panel could possibly be attached on either side of the opening, then rolled and stored on one side or the other.

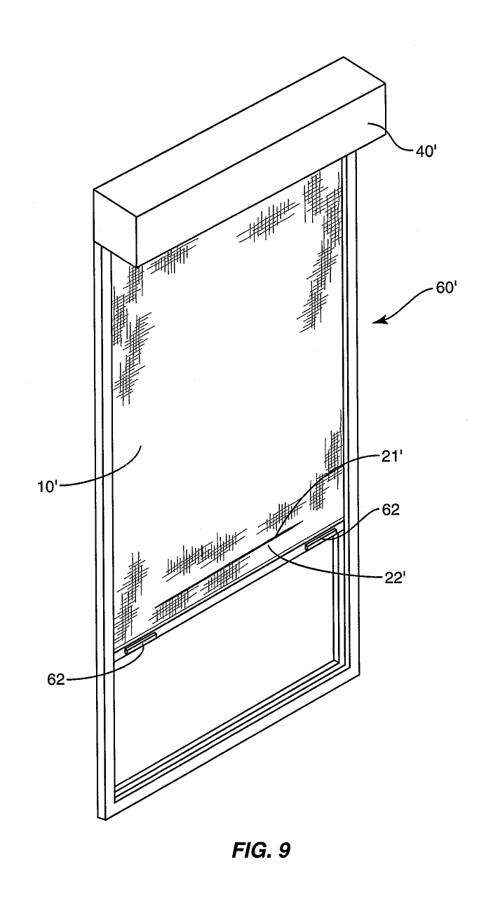

FIG. 9 illustrates another embodiment of a closure system contemplated by the present invention. As shown, FIG. 9 shows closure system 60 partially deployed wherein only a portion of the window is shown covered by panel 10′. During periods where a storm is not present and a threat to the structure, panel 10′ can be coiled up into storage container 40. As the need may arise, the installer or property owner can deploy panel 10′ at his election by pulling the panel 10 down, thus unwinding the coil in the storage panel so as to cover the window opening. Access to the outside in many of these installations is required to complete the closing and securing operation.

An elongated opening 21′ is disposed proximate to the lower portion of panel 10′. Thus, access is permitted from the interior of the structure towards the exterior so as to facilitate the securement of the lower portion of panel 10′ to the bottom portion of the bottom edge of the window opening. As can be understood, this is an embodiment where the zippered elongate opening 21′ works cooperatively with a closure system that has a permanent installment feature. When the threat of damage has passed, a user can unzip the closure or the elongated opening, reach out, disengage the bottom portion or the sides of the panel as needed, and then recoil the fabric panel into the storage housing as may be desired.

Referring again to FIG. 9, this embodiment includes a storage housing 40 positioned above the window opening. The storage housing 40 retains the storm panel 10′ in coiled like fashion when there is no threat of damage. At the user's election, the storm panel 10′ is deployed over the window by uncoiling the storm panel 10′ from inside storage housing 40 so as to adequately cover the window. A user can then selectively attach the storm panel 10′ to the structure surrounding the window in advance of a storm as needed. The embodiment shown uses a guiding mechanism, or guide bar disposed at opposing sides of the window to facilitate deployment of storm panel 10. When the storm panel 10′ fully deployed a variety of mechanical fasteners, as is known in art, can be used to secure storm panel 10 to the structure surrounding the window. Here, a slide fastener having buttons 62 are slidable and operably connected to locking mechanism in the flange. The buttons 62 are accessed through the elongate opening 21′ when the storm panel 10′ is deployed to engage and release the locking mechanism (not shown) in the flange at the bottom portion of storm panel 10′. The elongate opening 21′, itself selectively closable by a zipper or one of the other closure or fastener devices described above, permits access to the exterior of the structure when the storm panel 10′ is deployed. When the threat has passed, the storm panel 10′ is releasable from the structure. The elongate opening 21′ thus permits a user to access the exterior to engage and disengage the storm panel 10′ from the structure surrounding the window.

### EXAMPLE 1

A flexible composite fabric was formed from a single ply fabric made of ultra high molecular weight, extended chain polyethylene fibers. The fibers were Spectra® 900, 650 denier yarn available from Honeywell International Inc. and had a tenacity of 30.5 g/d. The fabric was in the form of a plain weave woven fabric (style 904 made by Hexcel Reinforcements Corp.), characterized as having a weight of 6.3 oz/yd² (0.02 g/cm²), 34 ×34 ends per inch (13.4×13.4 ends per cm), a yarn denier of 650 in both the warp and weft, and a thickness of 17 mils (425 μm). The fabric was laminated on both sides to a low density polyethylene film having a thickness of 1.5 mil (37.5 μm). A 4 mil (100 μm) film of ethylene vinyl acetate was used as a bonding layer between the fabric layer and the two polyethylene film layers. The layers were laminated together by a thermal lamination technique as described in U.S. Pat. Nos. 6,280,546 and 6,818,091.

The total composite fabric weight was 14.8 oz/yd² (0.05 g/cm²), and the total composite fabric thickness was 0.030 inch (0.76 mm). The composite had a grab strength in the range of 850 to 950 pounds per inch (148.8 kN/m) of fabric width, as measured by ASTM 1682.

The percent transmitted light through this composite was found to be about 80% (test method based on ASTM D1746).

This fabric, when constructed into a storm panel and provided with a selectively closeable elongated opening as described above, effectively protects the underlying opening.

### EXAMPLE 2

A flexible composite fabric was formed from a single ply fabric made of extended chain polyethylene fibers. The fibers were Spectra® 900, 1200 denier yarn available from Honeywell International Inc. and had a tenacity of 30 g/d. The fabric was in the form of a basket weave woven fabric (style 912 made by Hexcel Reinforcements Corp.), characterized as having a weight of 11.3 oz/yd² (0.044 g/cm²), 34×34 ends per inch (13.4×13.4 ends per cm), a yarn denier of 1200 in both the warp and weft, and a thickness of 28 mils (700 μm). The fabric was laminated on both sides to a low density polyethylene film having a thickness of about 2 mils (10 μm). A 7-8 mil (175-200 μm) film of ethylene vinyl acetate was used as a bonding layer between the fabric and the two polyethylene film layers. The layers were laminated together by a thermal lamination technique as described in U.S. Pat. Nos. 6,280,546 and 6,818,091.

The total composite fabric weight was 20 oz/yd² (0.07 g/cm²), and the total composite fabric thickness was 0.045 inch (1.14 mm). The composite had a grab strength in the range of 1700 to 1900 pounds per inch (298-333 kN/m) of fabric width, as measured by ASTM 1682. This fabric, when constructed into a storm panel and provided with a selectively closeable elongate opening as described above, also effectively protects the underlying opening.

The foregoing description is illustrative of a preferred embodiment of the present invention, however it is apparent that various changes may be made without departing from the scope of the invention. For example, as described above, the system may be utilized with various types of building structures which would require various types of anchoring systems. The storm panel may be attached to the vertical surface of a building, the window or door facings, or the horizontal undersurface of an opening facing. There may be utilized the optional grommeted side openings which provide further reinforcement of the panel. Various configurations of the selectively closeable elongate openings may be provided to conform to various window and door sizes and placements. While a specific film/fabric laminate is described above, the flexible panel may also be a fabric, a film, or a coated fabric Thus, various modifications and variations are possible. It is intended that the scope of the invention be limited not by the description of the preferred embodiments above, but rather by the following claims.

We claim:

1. A system for protecting the window or door of a structure during high winds such as those accompanying hurricanes comprising:
a) a flexible panel of such size and shape as to substantially extend across and cover the corresponding window or door for which it is intended;
b) a closure system selectively attaching the panel to the structure adjacent the window or door in advance of a storm and being releasable from the structure after the storm;
c) a selectively closeable elongate opening formed in the panel, the selectively closeable elongate opening permitting access from the interior of the structure to the exterior of the structure, whereby access to the closure system is provided for securing and releasing the closure system from inside the structure.

2. The system of claim 1, wherein the panel is a fabric selected from group consisting of woven fabrics, warp knit fabrics, weft knit fabrics, mesh fabrics, nonwoven fabrics and polymeric films.

3. The system of claim 1, wherein the panel is a fabric formed from fibers selected from the group consisting of polyester, polyamide, polypropylene, ultra high molecular weight polypropylene, polylactic acid, acrylic, polyethylene, ultra high molecular weight polyethylene, aramids, para aramids, ultra high molecular weight aramids, and blends of such fibers.

4. The system of claim 1, wherein the panel is a laminate comprising a first layer having first and second sides and at least a second layer, the second layer adjacent to either side of the first layer, the second layer comprising a film.

5. The system of claim 4, wherein the film is selected from the group consisting of polyethylene, low density polyethylene, ethylene, and vinyl acetate.

6. The system of claim 1, wherein the panel is a film selected from the group consisting of polyethylene, low density polyethylene, ethylene, and vinyl acetate.

7. The system of claim 1, wherein the panel is a laminate comprising a first layer having first and second sides and at least a second layer, the second layer adjacent to either side of the first layer, the second layer comprising a polymer coating.

8. The system of claim 7, wherein the polymer coating is selected from the group consisting of acrylic, polyvinyl chloride, polyvinyl acetate or polyurethane.

9. The system of claim 1, wherein the panel includes a perimeter, and the closure system includes a plurality of holes with grommets along at least a portion of the perimeter of the panel through which anchors may be placed into the underlying wall structure adjacent of the window or door.

10. The storm panel according to claim 1, wherein the selectively closable elongate opening extends across a portion of the panel and further includes a closure material for selectively opening and closing the elongate opening.

11. The system of claim 10, wherein the closure material is selected from the group consisting or zippers, hook-and-loop material, buttons, snaps, and combinations thereof.

12. In a storm curtain system which includes a fabric panel and a closure system requiring access from the exterior for selectively attaching the panel, the improvement comprising:
a) a flexible panel of such size and shape as to substantially extend across the corresponding window or door of a structure;
b) a selectively closeable elongate opening formed in the panel, the selectively closeable elongate opening permitting access form the interior of the structure to the exterior of the structure, whereby access to the closure system is provided for securing and releasing the closure system from inside the structure.

13. The improved storm curtain system of claim 12, wherein the flexible panel is selected from the group consisting of woven fabrics, warp knit fabrics, weft knit fabrics, mesh fabrics, nonwoven fabrics, polymeric films, film/fabric laminates, and coating/fabric laminates

14. The improved storm curtain system of claim 13, wherein the flexible panel is a fabric formed from fibers selected from the group consisting of polyester, polyamide, polypropylene, ultra high molecular weight polypropylene, polylactic acid, acrylic, polyethylene, ultra high molecular weight polyethylene, aramids, para aramids, ultra high molecular weight aramids, and those formed of blends of such fibers.

15. The improved storm curtain system of claim 13, wherein the flexible panel is a laminate comprising a first fabric layer having first and second sides and at least a second layer, the second layer adjacent to either side of the first layer, the second layer comprising a film.

16. The system of claim 13, wherein the film is selected from the group consisting of polyethylene, low density polyethylene, ethylene, and vinyl acetate.

17. The improved storm curtain system of claim 13, wherein the flexible panel is a laminate comprising a first layer having first and second sides and at least a second layer, the second layer adjacent to either side of the first layer, the second layer comprising a polymer coating.

18. The improved storm curtain system of claim 17, wherein the polymer coating is selected from the group consisting of acrylic, polyvinyl chloride, polyvinyl acetate or polyurethane.

19. The improved storm curtain system of claim 12, wherein the closure system includes a storage housing capable of retaining a fabric panel in a coiled position above window.

20. The improved storm curtain system of claim 12, wherein the selectively closable elongate opening extends across a portion of the panel and further includes a closure material for selectively opening and closing the elongate opening.

21. The improved storm curtain system of claim 20, wherein the closure material is selected from the group consisting or zippers, hook-and-loop material, buttons, snaps, and combinations thereof.

22. The improved storm curtain system of claim 12, wherein the flexible panel is a film selected from the group consisting of polyethylene, low density polyethylene, ethylene, and vinyl acetate.

23. The improved curtain system of claim 12, wherein the flexible panel includes a perimeter, and the closure system includes a plurality of holes with grommets along at least a portion of the perimeter of the panel through which anchors may be placed which extend into the underlying wall structure adjacent the window or door.
